(19) United States
(12) Patent Application Publication
(10) Pub. No.: US 2008/0263040 A1
(43) Pub. Date: Oct. 23, 2008

(54) System and method for making a face call

(76) Inventor: Nikhilesh Talreja, Mumbai (IN)

Correspondence Address: ARENT FOX LLP, 1050 CONNECTICUT AVENUE, N.W., SUITE 400, WASHINGTON, DC, 20036, US

(21) Appl. No.: 12/078,532

(22) Filed: Apr. 1, 2008

Related U.S. Application Data
(60) Provisional application No. 60/907,436, filed on Apr. 2, 2007.

(51) Int. Cl. G06F 17/30; G06F 7/00

(52) U.S. Cl. 707/6; 707/104.1; 707/E17.032; 707/E17.029; 707/E17.044

(57) ABSTRACT

A system and method for making a face call is provided. The method includes receiving (402) a first picture, where the first picture is sent from a first communication device (102) by a first user. Further, the method includes performing a visual search (404) of the first picture and presenting (406) search results to the first user. The method further includes selecting (408) a second picture of a second user from the search results, where the second picture is selected by the first user. Finally, the method includes facilitating (410) a communication session between the first user and the second user.

### CROSS-REFERENCE TO RELATED APPLICATIONS

This application claims the benefit of U.S. Provisional Patent Application No. 60/907,436 titled “Face Call” filed on Apr. 2, 2007, which is incorporated by reference herein in its entirety.

### BACKGROUND OF THE INVENTION

The present invention relates to the field of social networking, and more particularly, to a system and method for initiating a telecommunications session to a called party based on the called party's visual appearance.

Social networking is a phenomenon that is finding increasing acceptance in the internet world. A social network website focuses on identifying, authenticating, and connecting persons with shared interests or activities, or who are interested in exploring each others' interests and activities, and providing communications tools that permit them to build communities among each other. People on these social network websites get to know strangers in many different ways and use the network thus created for business or entertainment. Examples of social networking websites include Facebook™, MySpace™, Orkut™, Friendster™, Hi5™, Multiply™, Flickr™, and the like.

The explosive growth of the social networking websites industry over the past several years has spurred website owners continually to offer new and improved services with each generation of new social network website. These websites offer various search features to users to search for friends and people.

One limitation in available social network websites is that they typically allow only text-based search fields. If a user sees or meets somebody in real life, and likes that person and wants to know more about the person, he cannot do so until he has sufficient information about the person to search in the social network websites. Also, sometimes a user only has a picture of the person he wants to search about, but in the available social network websites, there is no such functionality of searching for a person of whom only a picture is available.

There is a need in the art for a system, which can address the problem of enabling users to search information based only on information available in real life, or the search target's visual appearance. Also, there is a need for a system where a person can be searched just from its photograph. Additionally, there is a need for a system where a photograph of a group of people can be used to search for the whole group without having to search for individual persons in the group. Additionally, there is a need in the art to initiate a telecommunications session by identifying a called party based on their appearance or photograph.

### BRIEF DESCRIPTION OF THE DRAWINGS

FIG. 1 illustrates an exemplary environment in which various embodiments of the present invention can be practiced.

FIG. 2 is a block diagram illustrating a system for making a face call, in accordance with an embodiment of the present invention.

FIG. 3 is a block diagram illustrating a system for making a face call, in accordance with another embodiment of the present invention.

FIG. 4 is a flowchart illustrating a method for making a face call, in accordance with an embodiment of the present invention.

FIG. 5 is a flowchart illustrating a method for making a face call, in accordance with another embodiment of the present invention.

FIG. 6 and FIG. 7 is an example for making a face call from a first communication device to a second communication device, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### SUMMARY OF THE INVENTION

One object of the present invention is to provide a system and method for providing visual search functionality to a social network website.

Another object of the present invention is to provide a system and method for searching a person or a product through its picture.

Yet another object of the present invention is to provide a system and method for searching a group of people through a group picture of the group.

The above and other objects of the present invention are achieved by providing a system and method for making a face call. A face call is a communication session between two or more users of a social network, where the two or more users are connected through visual search of one or more pictures.

In accordance with an embodiment of the present invention, the system for making a face call includes a reception module for receiving a first picture from a communication device, where a first user transmits that first picture to one or more databases containing a plurality of picture-based information affiliated with other users. The system further includes a search module for performing a visual search of the first picture in the one or more databases. Further, the system includes a presentation module for presenting matching pictures to the first user and a selection module for selecting a second picture from the matching pictures, where the second picture is selected by the first user. Finally, the system includes a communication module for establishing a communication between the first user and a second user, where the second picture was affiliated with the second user.

In accordance with an embodiment of the present invention, the method for making a face call includes receiving a first picture from a communication device, where a first user transmits that first picture to one or more databases containing pictures affiliated with other users. The method further includes performing a visual search of the first picture in the one or more databases. Further, the method includes presenting matching pictures searched from the one or more databases to the first user, where the matching pictures are sent to the communication device. Further, the method includes selecting a second picture from the matching pictures, where the second picture is selected by the first user. Finally, the method includes establishing a communication between the first user and a second user, where the second picture was affiliated with the second user.

### DETAILED DESCRIPTION OF THE INVENTION

Before describing in detail the particular method and system for creating and sending expressive messages in accordance with the present invention, it should be observed that the present invention resides primarily in combinations of method steps and system components related to creating and sending the expressive messages.

Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as ‘first’ and ‘second’, and the like may be used solely to distinguish one entity or action from another entity or action without necessarily requiring or implying any actual such relationship or order between such entities or actions. The terms ‘comprises’, ‘comprising’, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a’ does not, without more constraints, preclude the existence of additional identical elements in the process, method, article, or apparatus that comprises the element.

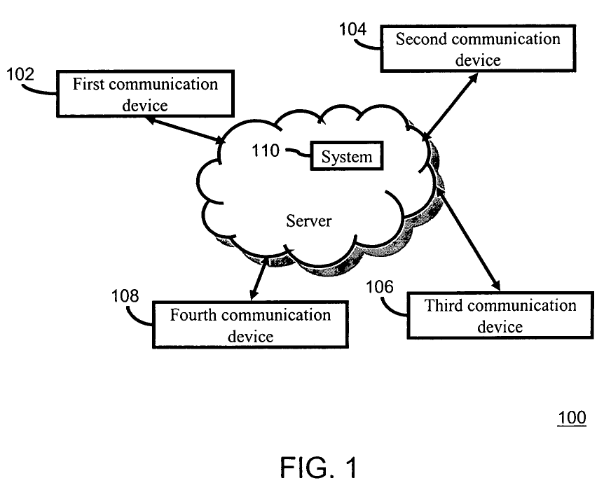

FIG. 1 illustrates an exemplary environment in which various embodiments of the present invention can be practiced. The environment includes a first communication device 102, a second communication device 104, a third communication device 106 and a fourth communication device 108. Examples of communication devices 102, 104, 106 and 108 include mobile phones, computers, laptops, digital cameras, Personal Digital Assistants (PDAs), tablet PCs, watches, fax machines, webcams, video recording cameras and the like. The communication devices 102, 104, 106 and 108 are capable of communicating with a server 100, which, among other information, can store and retrieve visual information corresponding to users. Examples of a server include a web server, a mobile server, an application server, a database server, a file server, a fax server, a client server, a peer-to-peer network and the like. The environment also includes a system 110 for making a face call. In an embodiment of the present invention, the first communication device 102 makes a face call to the second communication device 104.

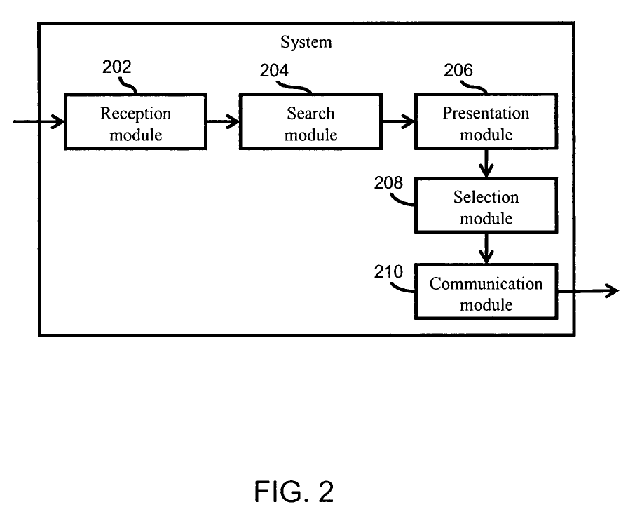

FIG. 2 is a block diagram illustrating a system 110 for making a face call, in accordance with an embodiment of the present invention. The face call can take place between two or more users of one or more databases, wherein a number of users correspond with or subscribe to those databases, and the databases are capable of storing, retrieving or accessing visual information corresponding with the users. Each of these users can also have one or more profiles stored on the one or more databases. In another embodiment of the present invention, a user or other users, or system 110 itself (automatically) can link the one or more profiles with its profiles on other social networks. Also, the user, other users or system 110 itself can import pictures from the other social networks. The system 110 includes a reception module 202, a search module 204, a presentation module 206, a selection module 208 and a communication module 210. The reception module 202 is capable of receiving a first picture from a first communication device 102, where the first picture is sent by a first user of the one or more databases. The search module 204 performs a visual search of the first picture in the one or more databases. The visual search can be performed using one of the image search technologies.

Examples of image search technologies existing in the art include Microsoft's image based web search, Real Time at alipr.com, Riya.com visual search, myHeritage.com image face recognition, Neven Vision image recognition and the like.

In another embodiment of the present invention, the search module 204 is capable of searching the one or more database for a group picture. For example, a picture of group of friends can be used to search for each of the friends present in the picture. The search module 204 searches each face or each object present in the picture in the one or more databases, and provides relevant results for the each face or the each object. The presentation module 206 presents a list of matching pictures searched visually from the one or more databases to the first user. The list of matching pictures is sent to the first communication device 102 or to another communication device specified by the first user. The pictures in the list of the matching pictures are arranged in decreasing order of its match to the first picture. The selection module 208 selects a second picture from the list of matching pictures, where the second picture is selected by the first user. The communication module 210 then establishes a communication session between the first user and the second user. Examples of the communication session include text messaging, multimedia messaging, email, Instant Message (IM) service, a voice call, voice SMS service, color SMS service, a Voice over Internet Protocol (VoIP) session, a Session Initiation Protocol (SIP) session, a video call and the like.

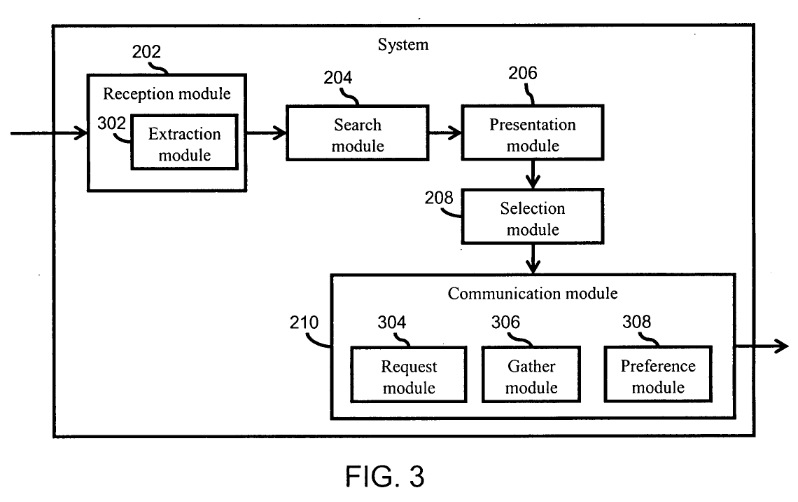

FIG. 3 is a block diagram illustrating a system 110 for making a face call, in accordance with another embodiment of the present invention. The face call can take place between two or more users of one or more databases, where the one or more databases have a number of users. Each of these users has one or more profiles stored on the one or more databases. Each of these profiles contains one or more pictures uploaded by the respective user. Each of these profiles also contains information about a preferred mode of communication of the respective user, where the preferred mode of communication can be selected from text messaging, multimedia messaging, email, Instant Message (IM) service, a voice call, voice SMS service, color SMS service, a Voice over Internet Protocol (VoIP) session, a Session Initiation Protocol (SIP) session and a video call. In another embodiment of the present invention, a user can link the one or more profiles with its profiles on other social networks. Also, the user, other users, or system 110 itself can import pictures from the other social networks. The system 110 includes a reception module 202, a search module 204, a presentation module 206, a selection module 208 and a communication module 210. The reception module 202 is capable of receiving a first picture from a first communication device 102, where the first picture is sent by a first user of the one or more databases. The search module 204 performs a visual search of the first picture in the one or more databases. The presentation module 206 presents a list of matching pictures searched visually from the one or more databases to the first user. The selection module 208 selects a second picture from the list of matching pictures, where the second picture is selected by the first user. The communication module 210 then establishes a communication session between the first user and the second user.

The reception module 202 includes an extraction module 302. The extraction module 302 extracts a picture from a message received at the reception module 202. The first user can send a picture in a message through one or more of an email, a multimedia message, directly as an attachment, Bluetooth, internet, infrared and the like. The extraction module 302 then extracts the picture from that message for visual search.

In another embodiment of the present invention, the search module 204 is capable of searching the one or more database for a group picture. For example, a picture of group of friends can be used to search for each of the friends present in the picture. The search module 204 searches each face or each object present in the picture in the one or more databases, and provides relevant results for the each face or the each object.

Another embodiment of the present invention protects a called-party's privacy, by permitting that called party to accept or refuse telecommunications based on information corresponding to the calling party. The communication module 210 includes a request module 304, a gather module 306 and a preference module 308. The request module 304 sends a request to the second user to seek consent before establishing a communication with the first user. The request also comprises information about the first user, to help the second user reach a decision. The gather module 306 receives the consent of the second user for communication session with the first user. The preference module 308 collects the information about the preferred mode of communication of the second user. The information can be obtained from the profile of the second user or the second user can provide the preferred mode of communication on receiving the request for communication. The communication module 210 then establishes a communication session between the first user and the second user using the preferred mode of communication of the second user.

In another embodiment of the present invention, the gather module 306 does not receive the consent of the second user for communication with the first user. As a result, various outcomes can be possible. Optionally, no communication session is established between the first user and the second user. Alternatively, the first user receives a message that communications with the second user is unavailable, has been refused, failed, or the like. As another alternative, the second user can respond with an automated or customized message apologizing that she is unavailable, or requesting further information about the first user before she accepts communications. Other alternatives could include leaving a message for the second user, or having the communications session diverted to the second user's assistant or answering service.

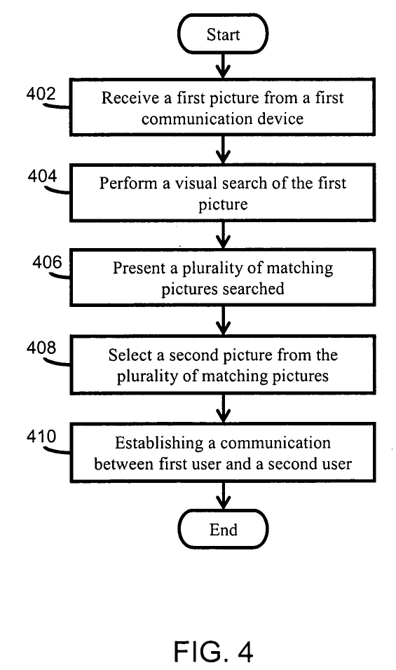

FIG. 4 is a flowchart illustrating a method for making a face call based on visual search for a to-be-called party, in accordance with an embodiment of the present invention. The face call can take place between two or more users of one or more databases, where the one or more databases have a number of users. Each of these users has one or more profiles stored on the one or more databases. At step 402, a first picture is received from the first communication device 102, where the first picture is sent by a first user. At step 404, visual search of the first picture is performed in the one or more databases. The results of the visual search are presented to the first user as a list of matching pictures at step 406. The matching pictures are the ones which are close matches of the first picture, the close matches being obtained through the visual search. At step 408, the first user selects a second picture from the list of matching pictures. The second picture belongs to a second user. Further at step 410, a communication session is established between the first user and the second user.

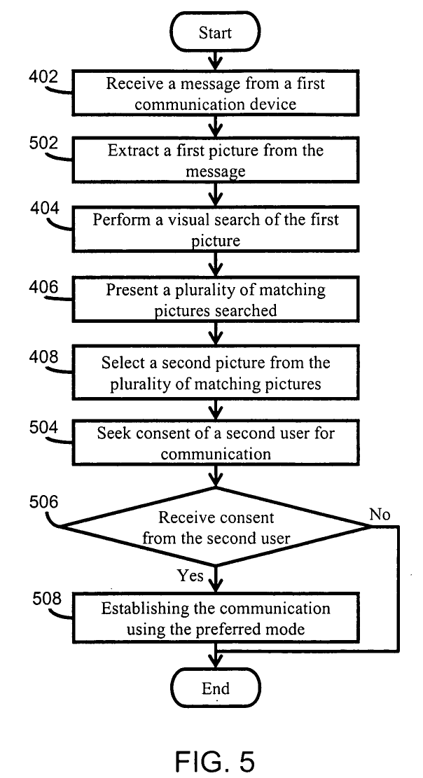

FIG. 5 is a flowchart illustrating a method for making a face call based on submitting a photograph or visual information about a to-be-called party, in accordance with another embodiment of the present invention. The face call can take place between two or more users of one or more databases, where the one or more databases have a number of users. Each of these users has one or more profiles stored on the one or more databases. At step 402, a message containing a first picture is received from the first communication device 102, where the first picture is sent by a first user. The first picture is extracted from the message at step 502. At step 404, visual search of the first picture is performed in the one or more databases. The results of the visual search are presented to the first user as a list of matching pictures at step 406. The matching pictures are the ones which are close matches of the first picture, the close matches being obtained through the visual search. At step 408, the first user selects a second picture from the list of matching pictures. The second picture belongs to a second user. At step 504, a request is sent to the second user, seeking consent before establishing a communication session with the first user. At step 506, consent of the second user for communication is received. Further at step 410, a communication session is established between the first user and the second user. In another embodiment of the present invention, consent of the second user for communication is not received. As a result, no communication session is established between the first user and the second user, or the session is diverted to one of the other sorts of alternatives described above, when a called-party refuses to receive a face call initiated by a first user.

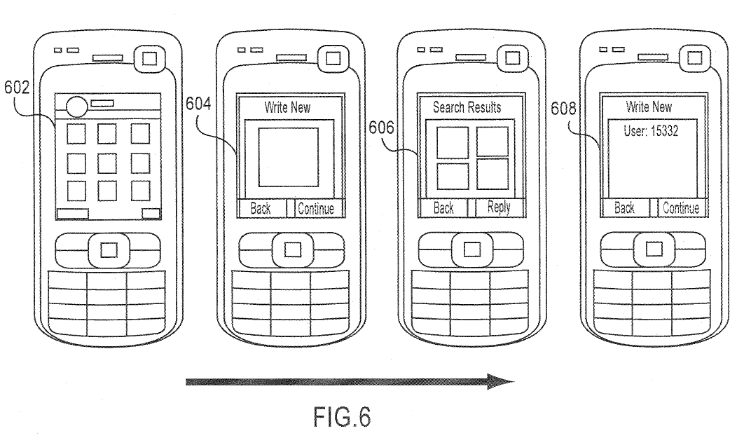

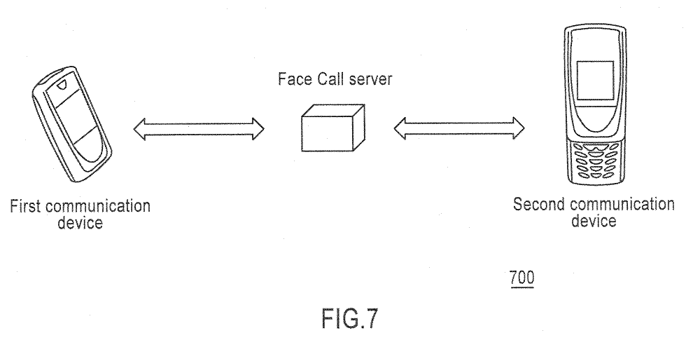

FIG. 6 and FIG. 7 is an example for making a face call from a first communication device 102 to a second communication device 104, with picture message functionality in accordance with an embodiment of the present invention. A first user of the first communication device 102 makes a face call to a second user, in accordance with an embodiment of the present invention. FIG. 6 illustrates a sample User Interface (UI) of the first communication device 102. The screen 602 of the first communication device shows that the first user can initiate a face call using the picture message functionality. The screen 604 shows that the first user composes a picture message, using a picture of the second user or a picture of the person in close resemblance to the second user. The picture message is then sent to Face Call Server. The Face Call Server visually searches the picture, and sends the results back to the first user. The screen 606 shows the search results displayed on the screen of the first communication device. Each picture displayed in the search results also contains a pre-specified code for the user attached to it. The first user can then select one of the search results, and inform the Face Call Server about the user to whom he desires to place a face call. The screen 608 shows that the first user has composed a message containing the user code for the second user. The first user then sends that message to the Face Call Server. FIG. 7 illustrates how the Face Call Server establishes a communication session between the first communication device 102 and the second communication device 104. The Face Call Server sends a request to the second communication device 104, where the request seeks the consent of the second user for communication with the first user. The request also contains profile information of the first user. The second user then accepts the request, and the Face Call Server establishes a communication session between the first user and the second user.

Thus it is concluded that face call can serve the purpose of connecting people in a social network without being limited to connecting to people for whom the information is available. Also, face call can be used for profile matching. A person can search for the users matching the face cut of his/her favorite celebrity or another person he/she liked.

The face call can also be used to detect criminals. If a user clicks the picture of a criminal and searches on the face call server, if the profile of the criminal exists on face call server, the user will be alerted about the criminal background of that person. Another use of face call can be for searching of music album cover or a poster. If a user searches for an album cover, the face call server can connect the user to a store selling that album. Other possible use cases of face call include but are not limited to: (i) If a car driver is badly hit in an accident, the number plate of the car can be photographed and used to socially network with the owner of the car; (ii) A picture of an animal can be used to find out the nearby location of a zoo or museum that holds that animal species and some more information on the animal species can be also provided through the server; (iii) A piece of text can be photographed and searched for text based searching or for finding the translation of that piece of text; (iv) A location or landmark can be photographed and visually searched to find out the nearby restaurants and clubs etc. and (v) A picture of the sky is clicked and visually searched to get a forecast on the weather and an estimate on the outside atmospheric temperature; and (vi) A user can use the system to search a life partner or a dating partner on a matrimonial website or a dating website using a picture of a celebrity or another person of his choice.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The examples under the present invention, detailed in the illustrative examples contained here, are described using terms and constructs drawn largely from internet and GSM mobile telephony infrastructure. However, use of these examples should not be interpreted to limiting the invention to those media. The capabilities of the visited or non-accustomed network can be of use and provided through any type of internet and telecommunications medium, including without limitation: (i) any mobile telephony network including, without limitation, GSM, 3GSM, 3G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent subscriber id such as the eye2eye devices from Dlink; or telecommunications equipment meant for voice over IP communications such as those provided by Vonage or Packet 8.

What is claimed is:

1. A system for making a face call among users of one or more databases, the one or more databases comprising a plurality of users, each user of the plurality of users having one or more profiles stored in the one or more databases, the system comprising:
a reception module for receiving a first picture sent by a first user of the users of the one or more databases from a first communication device;
a search module for performing a search of the first picture in the one or more databases;
a presentation module for presenting one or more pictures matching the first picture from the one or more databases to the first user;
a selection module for selecting a second picture from the one or more matching pictures, where the second picture is selected by the first user; and
a communications module for facilitating a communication between the first user and a second user of the users of the one or more databases, where the second picture corresponds to the second user.

2. The system recited in claim 1, wherein the first communication device is selected from a group consisting of a mobile phone, a computer, a laptop, a digital camera, a Personal Digital Assistant (PDA), a tablet Personal Computer (PC), a fax machine, a webcam, a handy cam and a watch.

3. The system recited in claim 1, wherein each profile of the one or more profiles comprises at least one picture.

4. The system recited in claim 1, wherein each profile of the one or more profiles comprises information about a preferred mode of communication of a user of the profile.

5. The system recited in claim 4, wherein the preferred mode of communication is selected from a group consisting of text messaging, multimedia messaging, email, Instant Message (IM) service, a voice call, voice SMS service, color SMS service, a Voice over Internet Protocol (VoIP) session, a Session Initiation Protocol (SIP) session and a video call.

6. The system recited in claim 1, the communications module comprising:
a preference module for collecting information about a preferred mode of communication of the second user.

7. The system recited in claim 1, the communications module comprising:
a request module for requesting a consent of the second user before facilitating the communication with the first user.

8. The system recited in claim 6, the communications module further comprising:
a receiving module for receiving the consent of the second user for facilitating the communication with the first user.

9. The system recited in claim 1, the first picture being sent by the first of the two or more users via a message, the reception module comprising:
an extraction module for extracting the first picture from the message.

10. The system recited in claim 1, wherein each database of the one or more databases is hosted on one selected from a group consisting of a server, a storage device and a communication device.

11. A method for making a face call among users of one or more databases, the one or more databases comprising a plurality of users, each user of the plurality of users having one or more profiles stored on the one or more databases, the method comprising:
receiving a first picture sent by a first user of the users of the one or more databases from a first communication device;
performing a search of the first picture in the one or more databases;
presenting one or more pictures matching the first picture from the one or more databases to the first user;
selecting a second picture from the one or more matching pictures, where the second picture is selected by the first user; and
facilitating a communication between the first user and a second user of the users of the one or more databases, where the second picture corresponds to the second user.

12. The method recited in claim 11, wherein the first communication device is selected from a group consisting of a mobile phone, a computer, a laptop, a digital camera, a Personal Digital Assistant (PDA), a tablet Personal Computer (PC), a fax machine, a webcam, a handy cam and a watch.

13. The method recited in claim 11, wherein each profile of the one or more profiles comprises at least one picture.

14. The method recited in claim 11, wherein each profile of the one or more profiles comprises information about a preferred mode of communication of user associated to the each profile.

15. The method recited in claim 14, wherein the preferred mode of communication is selected from a group consisting of text messaging, multimedia messaging, email, Instant Message (IM) service, a voice call, voice SMS service, color SMS service, a Voice over Internet Protocol (VoIP) session, a Session Initiation Protocol (SIP) session and a video call.

16. The method recited in claim 11, the second user having a preferred mode of communication, wherein facilitating the communication comprises:
using the preferred mode of communication of the second user.

17. The method recited in claim 11, wherein facilitating the communication comprises:
requesting a consent of the second user before facilitating the communication.

18. The method recited in claim 17, wherein facilitating the communication further comprises:
receiving the consent of the second user for facilitating the communication.

19. The method recited in claim 11, the first picture being sent by the first of the two or more users via a message, wherein receiving the picture comprises:
extracting the first picture from the message.

20. The method as recited in claim 11, wherein each database of the one or more databases is hosted on one selected from a group consisting of a server, a storage device and a communication device.

21. A computer program product for use with a computer, the computer program product comprising a computer usable medium having a computer readable program code stored therein for making a face call among users of one or more databases, the one or more databases comprising a plurality of users, each user of the plurality of users having one or more profiles stored on the one or more databases, the computer program product performing the steps of:
receiving a first picture sent by a first user of the users of the one or more databases from a first communication device;
performing a search of the first picture in the one or more databases;
presenting one or more pictures matching the first picture from the one or more databases to the first user;
selecting a second picture from the one or more matching pictures, where the second picture is selected by the first user; and
facilitating a communication between the first user and a second user of the users of the one or more databases, where the second picture corresponds to the second user.
